(19) United States
(12) Patent Application Publication
(10) Pub. No.: US 2025/0173187 A1
(43) Pub. Date: May 29, 2025

(54) COMPUTATION ARCHITECTURE CAPABLE OF EXECUTING NESTED FINE-GRAINED PARALLEL THREADS

(71) Applicant: University of Maryland, College Park, College Park, MD (US)

(72) Inventor: Uzi Yehoshua Vishkin, Potomac, MD (US)

(21) Appl. No.: 18/958,732

(22) Filed: Nov. 25, 2024

Related U.S. Application Data
(60) Provisional application No. 63/602,464, filed on Nov. 24, 2023.

(51) Int. Cl. G06F 9/50; G06F 9/54

(52) U.S. Cl. CPC G06F 9/5027; G06F 9/544; G06F 2209/5018; G06F 2209/543

(57) ABSTRACT

An accelerator apparatus cooperates with at least one processing core and a memory. The accelerator apparatus includes: a plurality of thread execution units (TEU) configured to execute a plurality of threads in parallel, and a thread buffer interconnected with the thread execution units. Based on an instruction indicating a thread to be executed, the thread buffer retrieves, from the memory, at least some data to be used by the thread. Based on a TEU among the plurality of TEUs being available and the at least some data to be used by the thread being retrieved, the thread buffer provides the thread and the at least some data to the available TEU. The thread buffer is separate from the memory, and the plurality of TEUs is separate from the at least one processing core.

### CROSS-REFERENCE TO RELATED APPLICATIONS

The present application claims priority to U.S. Provisional Application No. 63/602,464, filed Nov. 24, 2023, which is hereby incorporated by reference herein in its entirety.

### TECHNICAL FIELD

The present disclosure relates to computation architectures, and more particularly, to a computation architecture for executing instructions in parallel.

### BACKGROUND

Current multi-core and graphics processing unit (GPU) hardware approaches fail to extract their full potential performance benefits from some fine-grained parallel algorithms, due to their overheads. Fine-grained parallel algorithms play dominant roles in important applications, such as hardware and software verification technologies. Fine-grained parallelism refers to parallelism of threads that are relatively short. Very short threads may be referred to as “microthreads.” Tendencies by some fine-grained parallel code to rely on pointer-based data structure and fine-grained nesting of computing threads are of particular concern.

Going forward, more and more computer programs may originate from artificial intelligence (AI)-type systems. Given the rate in which AI systems produce computer programs, most of them still faulty, there is an increasing interest in testing or validating automatically such programs and in doing it as fast as possible. An important routine in state-of-the-art commercial verification technology software has fine-grained parallelism. Yet, exploitation of such parallelism on current information processing systems can be significantly improved. Accordingly, there is interest in improving the execution of programming instructions that include fine-grained parallelism.

### SUMMARY

The present disclosure relates to a computation architecture for executing instructions in parallel. In aspects of the present disclosure, the computation architecture includes an accelerator/coprocessor in a computing system for executing fine-grained parallelism with reduced overheads.

In accordance with aspects of the present disclosure, an accelerator apparatus cooperates with at least one processing core and a memory. The accelerator apparatus includes: a plurality of thread execution units (TEU) configured to execute a plurality of threads in parallel; and a thread buffer interconnected with the plurality of thread execution units. Based on an instruction indicating a thread to be executed, the thread buffer retrieves, from the memory, at least some data to be used by the thread. Based on a TEU among the plurality of TEUs being available and the at least some data to be used by the thread being retrieved, the thread buffer provides the thread and the at least some data to the available TEU. The thread buffer is separate from the memory, and the plurality of TEUs is separate from the at least one processing core.

In various embodiments of the accelerator apparatus, each TEU of the plurality of TEUs is configured to perform processing independently of any other TEU of the plurality of TEUs.

In various embodiments of the accelerator apparatus, each TEU of the plurality of TEUs is configured to execute a thread and to terminate the thread after execution of the thread is completed, and the thread is terminated without waiting for any child threads to be completed.

In various embodiments of the accelerator apparatus, each TEU of the plurality of TEUs is configured to execute a same stencil code.

In various embodiments of the accelerator apparatus, each TEU of the plurality of TEUs includes an instruction memory storing the stencil code. The stencil code is preloaded into the instruction memory of each of the plurality of TEUs prior to any data being provided to the TEU for thread execution.

In various embodiments of the accelerator apparatus, in the thread buffer retrieving, from the memory, the at least some data to be used by the thread, the thread buffer performs an irregular memory access.

In various embodiments of the accelerator apparatus, the thread buffer holds the at least some data until a TEU among the plurality of TEUs becomes available.

In various embodiments of the accelerator apparatus, the accelerator apparatus further includes a spawn waiting buffer configured to hold spawn information of a thread.

In various embodiments of the accelerator apparatus, based on a slot of the thread buffer being available, the spawn waiting buffer spawns a thread and provides the spawned thread to the available slot of the thread buffer.

In various embodiments of the accelerator apparatus, the spawn waiting buffer holds the spawn information and does not spawn a thread until a slot of the thread buffer becomes available.

In various embodiments of the accelerator apparatus, the accelerator apparatus further includes a control unit. The control unit is configured to: provide spawn information of threads to the spawn waiting buffer, provide an indication to the spawn waiting buffer based on a slot of the thread buffer being available, and provide an indication to the thread buffer based on a TEU of the plurality of TEUs being available.

In various embodiments of the accelerator apparatus, the control unit dynamically controls spawning and execution of threads.

In various embodiments of the accelerator apparatus, in the dynamic control, the control unit, based on the spawn waiting buffer being full or approaching fullness, suspends further spawning of threads and causes storage of seeds. The seeds include information of threads to be spawned.

In various embodiments of the accelerator apparatus, in the dynamic control, the control unit dynamically allocates an available TEU of the plurality of TEUs to receive a spawned thread from the thread buffer.

In various embodiments of the accelerator apparatus, the available TEU executes the thread, and in case the executing the thread spawns a nested thread, the thread buffer is repopulated with the nested thread by the thread buffer receiving and storing the nested thread.

In various embodiments of the accelerator apparatus, the available TEU terminates the thread after execution of the thread is completed. The thread is terminated without waiting for the nested thread to be completed.

In accordance with aspects of the present disclosure, an integrated system includes: a host system; and an accelerator apparatus as in any one of the accelerator apparatus above.

In accordance with aspects of the present disclosure, disclosed is a method in an accelerator apparatus that cooperates with at least one processing core and a memory. The method includes: based on an instruction indicating a thread to be executed, retrieving, by a thread buffer from the memory, at least some data to be used by the thread; based on a thread execution unit (TEU) among a plurality of TEUs being available and the at least some data to be used by the thread being retrieved, providing, by the thread buffer, the thread and the at least some data to the available TEU; and executing, by the plurality of TEUs, a plurality of threads in parallel. The thread buffer is separate from the memory, and the plurality of TEUs is separate from the at least one processing core.

In various embodiments of the method, each TEU of the plurality of TEUs is configured to perform processing independently of any other TEU of the plurality of TEUs.

In various embodiments of the method, each TEU of the plurality of TEUs is configured to execute a thread and to terminate the thread after execution of the thread is completed. The thread is terminated without waiting for any child threads to be completed.

In various embodiments of the method, each TEU of the plurality of TEUs is configured to execute a same stencil code.

In various embodiments of the method, each TEU of the plurality of TEUs includes an instruction memory storing the stencil code. The stencil code is preloaded into the instruction memory of each of the TEUs prior to any data being provided to the TEU for thread execution.

In various embodiments of the method, the retrieving, by the thread buffer from the memory, the at least some data to be used by the thread, includes: performing, by the thread buffer, an irregular memory access.

In various embodiments of the method, the method further includes: holding, by the thread buffer, the at least some data until a TEU among the plurality of TEUs becomes available.

In various embodiments of the method, the accelerator apparatus includes a spawn waiting buffer configured to hold spawn information of a thread.

In various embodiments of the method, the method further includes: based on a slot of the thread buffer being available, spawning, by the spawn waiting buffer, a thread and providing the spawned thread to the available slot of the thread buffer.

In various embodiments of the method, the spawn waiting buffer holds the spawn information and does not spawn a thread until a slot of the thread buffer becomes available.

In various embodiments of the method, the accelerator apparatus further includes a control unit. The control unit is configured to: provide spawn information of threads to the spawn waiting buffer, provide an indication to the spawn waiting buffer based on a slot of the thread buffer being available, and provide an indication to the thread buffer based on a TEU of the plurality of TEUs being available.

In various embodiments of the method, the method further includes: dynamically controlling, by the control unit, spawning and execution of threads.

In various embodiments of the method, the dynamic control includes: suspending, by the control unit based on the spawn waiting buffer being full or approaching fullness, further spawning of threads and causing storage of seeds. The seeds include information of threads to be spawned.

In various embodiments of the method, the dynamic control includes: dynamically allocating, by the control unit, an available TEU of the plurality of TEUs to receive a spawned thread from the thread buffer.

In various embodiments of the method, the method further includes: executing the thread by the available TEU; and in case the executing the thread spawns a nested thread, repopulating the thread buffer with the nested thread by the thread buffer receiving and storing the nested thread.

In various embodiments of the method, the method further includes: terminating, by the available TEU, the thread after execution of the thread is completed. The thread is terminated without waiting for the nested thread to be completed.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of an example of a computation architecture, in accordance with aspects of the present disclosure;

FIG. 2 is a diagram of an example of threads under two different implementations, in accordance with aspects of the present disclosure;

FIG. 3 is a diagram of an example of components of the waiting buffer and control module of the computation architecture of FIG. 1, in accordance with aspects of the present disclosure;

FIG. 4 is a diagram of an example of components of the accelerator/coprocessor of the computation structure of FIG. 1, in accordance with aspects of the present disclosure;

FIG. 5 is a diagram of an example of data relating to a certain atomic instruction, in accordance with aspects of an embodiment the present disclosure;

FIG. 6 is a diagram of an example of another embodiment of a computation architecture, in accordance with aspects of the present disclosure;

FIG. 7 is a flow diagram of an example of an operation for assigning threads, in accordance with aspects of the present disclosure;

FIG. 8 is an example of an algorithm for a Davis-Putnam-Logemann-Loveland (DPLL) solver;

FIG. 9 is an example of an algorithm for unit propagation;

FIG. 10 is diagram of an example of a graph whose nodes are the variables and the clauses of a conjunctive normal form (CNF) formula, in accordance with aspects of the present disclosure;

FIG. 11 is an example of an algorithm for parallel unit propagation with nested spawn-join;

FIG. 12 is an example of an algorithm for parallel unit propagation with joinless nested spawning, in accordance with aspects of the present disclosure;

FIG. 13 is an example of an algorithm for serial-style unit propagation, in accordance with aspects of the present disclosure; and

FIG. 14 is an example of an algorithm for parallel-style unit propagation, in accordance with aspects of the present disclosure.

### DETAILED DESCRIPTION

The present disclosure relates to a computation architecture for executing instructions in parallel. In aspects of the present disclosure, the computation architecture includes an accelerator/coprocessor in a computing system for executing fine-grained parallelism with reduced overheads.

With respect to computing systems, power considerations may pretty much preclude significant progress in clock rate. Computing technology is now in a state where significant performance growth likely requires scaling of parallelism, as demonstrated by the outstanding commercial success of GPUs for regular algorithms and applications such as computer graphics and machine learning. However, scaling of parallelism is yet to have a similar impact on irregular parallel algorithms and applications. Irregular parallel algorithms are those where distributions of work and data defy pre-runtime characterization because they are input-dependent; e.g., pre-runtime characterization cannot be adequately applied to complex, pointer-based data structures in graph algorithms for locality or load balancing, and cannot be applied to the transient embedding of heavily nested, input-dependent, fine-grained threads on concurrently executing hardware.

With respect to parallelizing irregular applications, proposals to address this challenge include: (i) extending platforms that originated from GPUs, (ii) using software-only methods on multicores, or (iii) software techniques in combination with hardware upgrades. While the first approach may achieve major impact on high-value commercial regular applications, it does not extend to irregular applications. The second approach has major shortcomings for irregular applications due to high overheads. For some irregular applications, parallelism may be quite limited. For example, for smaller quicksort input sizes, the overhead of spawning and managing kernel-level threads dwarfs the gain from parallel processing. For other applications, there may be no net gain for any input size, using software-only methods. The third approach-using software techniques along with hardware upgrades—has yet to gain traction, and there is insufficient literature on that approach. A missing element in these proposals is a satisfactory solution for the extremely fine level of nesting granularity and recursion that parallelization mandates for some computations.

The present disclosure addresses the following aspects: (i) parallelization with nested/recursive spawning as well as no “joins”, and (ii) implementation of parallelization with an integrated coprocessor/accelerator (and optionally co-design of a memory (e.g., 3D memory)) that: (a) prefetches the irregular memory accesses of spawned threads before activating them so that activated threads do not wait for memory, (b) performs out-of-order activation of threads based on their readiness to execute, (c) allows threads to terminate immediately after completion so that they do not wait for their child threads to complete and then perform a “join” operation, and/or (d) uses at/near-memory computation to initiate nested spawning of threads. An aspect of the present disclosure is that an activated thread undergoes minimal waiting and occupies the thread execution unit for only a short time. With respect to aspect (i), in various embodiments, the disclosed parallelization technique follows the principle that all of the threads generated from a Spawn command execute the same set of instructions, which may be referred to herein as a “stencil” or “stencil code,” but on different data elements. A very short thread, such as a thread executing stencil code, may be referred to herein as a “microthread.” The term “thread” may refer to any type of thread, including a microthread.

As mentioned above, fine-grained parallelism refers to parallelism of threads that are relatively short, as stencil code often is. Because fine-grained parallelism involves execution of relatively short code, the overhead to set up such parallel execution in conventional computing architectures is too high to achieve meaningful benefits from executing such fine-grained parallelism in said conventional computing architectures. Rather, conventional computing architectures perform better at executing longer parallel threads where the longer-running parallelism provides benefits that outweigh the costs of the overhead in setting up the parallel computing in the conventional computing architectures. As described below, disclosed is a computation architecture that includes an accelerator/coprocessor in a computing system for executing fine-grained parallelism with reduced overheads.

In the following description, certain specific details are set forth in order to provide a thorough understanding of disclosed aspects. However, one skilled in the relevant art will recognize that aspects may be practiced without one or more of these specific details or with other methods, components, materials, etc. In other instances, well-known structures have not been shown or described in detail to avoid unnecessarily obscuring descriptions of the aspects.

Reference throughout this specification to “one aspect” or “an aspect” means that a particular feature, structure, or characteristic described in connection with the aspect is included in at least one aspect. Thus, the appearances of the phrases “in one aspect” or “in an aspect” in various places throughout this specification are not necessarily all referring to the same aspect. Furthermore, the particular features, structures, or characteristics may be combined in any suitable manner in one or more aspects.

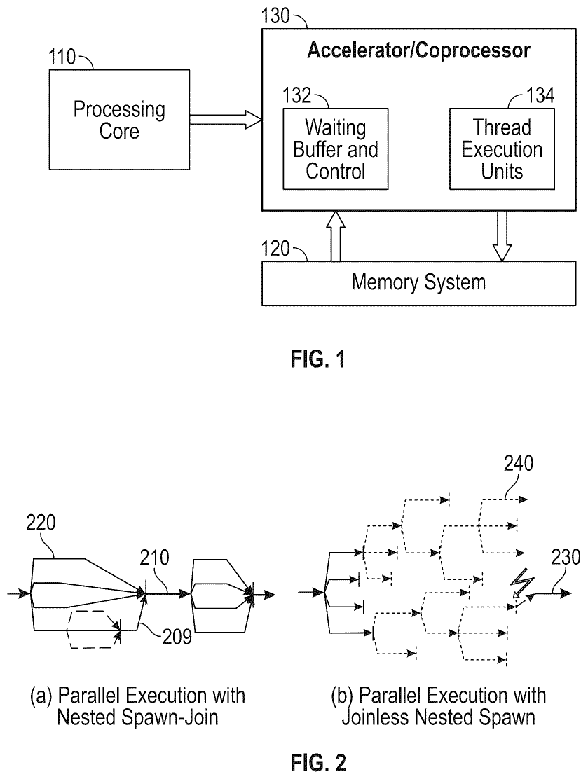

Referring to FIG. 1, there is shown a diagram of an example of an computation architecture. The computation architecture includes a processing core 110, a memory system 120, and an accelerator/coprocessor 130. The terms “accelerator” and “coprocessor” are used interchangeably herein to refer to hardware that accelerates certain computations and that coexist with a processing core, such as a central processing unit (CPU) core, a graphics processing unit (GPU) core, a tensor processing unit (TPU) core, among other possible processing cores.

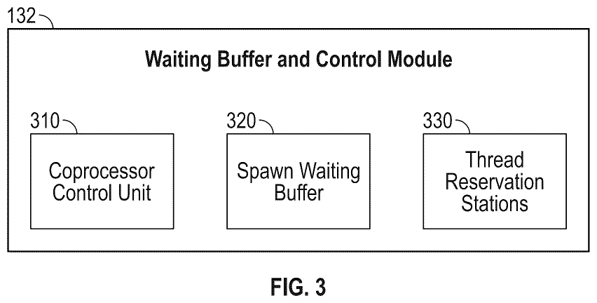

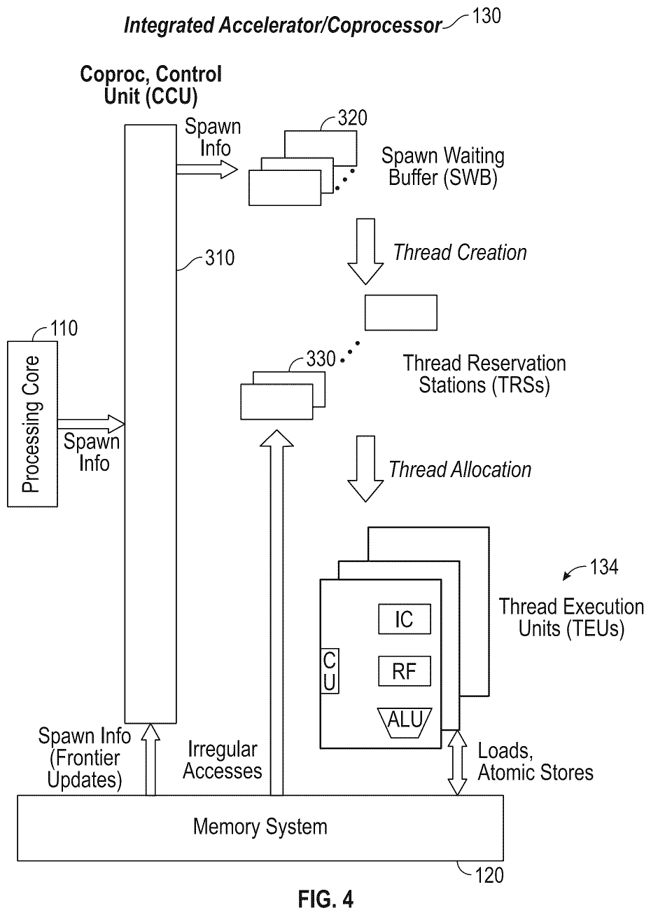

In accordance with aspects of the present disclosure, an accelerator/coprocessor 130 includes a waiting buffer and control module 132 and a plurality of thread execution units 134. In general, the waiting buffer and control module 132 prepares threads to be executed by the thread execution units 134. One embodiment of the waiting buffer and control module 132 and the thread execution units 134 will be described in more detail later herein in connection with FIG. 3 and FIG. 4. In short, the waiting buffer and control module 132 and the thread execution units 134 operate to reduce overhead in executing programming instructions that include fine-grained parallelism. As mentioned above, an aspect of the present disclosure is that an activated thread undergoes minimal waiting and occupies the thread execution unit for only a short time.

When part of an otherwise state of the art, or other general-purpose, or special-purpose, processing core, such as a CPU, GPU, or TPU, the accelerator/coprocessor 130 can provide an enhanced, yet overall balanced, hardware for executing routines that include nested fine-grained parallelization, such as unit-propagation routines, which will be described later herein. As such, it can be integrated with data or instruction memory hierarchies, such as the memory system 120, which can be adapted accordingly. For example, increased parallelism resulting from aspects of the present disclosure may require increased bandwidth to data caches feeding the accelerator/coprocessor 130. Given that extra parallelism can be traded for improved memory latency tolerance, significant performance advantages can be expected.

The accelerator/coprocessor 130 enables bypassing traditional multithreading overheads and provides competitive performance, partly when limited amounts of parallelism are available, even temporarily, or when parallelism changes rapidly, perhaps due to nested threads or short threads or both. Further aspects of the accelerator/coprocessor 130 will be described in more detail below in connection with FIG. 3 and FIG. 4.

Referring now to FIG. 2, there is shown an illustration of threads under an implementation (a) in which threads do not terminate until nested child threads are completed and a “join” operation is performed (referred to as “nested spawn-join”), and threads under an implementation (b) in which threads terminate immediately after completion and do not wait for their child threads to complete (referred to as “joinless nested spawn”). In implementation (a), child threads 220 always terminate at a “join” prior to spawning other threads, as happens prior to thread 209 or thread 210. In the implementation of (b), child threads 240 spawn directly new threads. Once they all terminate, a new thread 230 is started.

As mentioned above, aspects of the present disclosure provide parallelization with nested/recursive spawning with no “joins” and provide implementation of parallelization that allows threads to terminate immediately after completion so that they do not wait for their child threads to complete and then perform a “join” operation. An example of such threads is shown by the threads under implementation (b).

FIG. 2 merely provides examples and does not limit the scope of the present disclosure. Variations of the examples are contemplated to be within the scope of the present disclosure.

FIG. 3 is a diagram of an example of components of the waiting buffer and control module 132 of the computation architecture of FIG. 1. As shown in FIG. 3, the waiting buffer and control module 132 includes a coprocessor control unit 310, a spawn waiting buffer 320, and thread reservation stations 330. These components are described in more detail below in connection with FIG. 4.

FIG. 4 is a diagram of an example of components of the accelerator/coprocessor of the computation architecture of FIG. 1. As with FIG. 1, the computation architecture includes the processor core 110, the memory system 120, and the accelerator/coprocessor 130. The accelerator/coprocessor 130 includes the coprocessor control unit 310, the spawn waiting buffer 320, the thread reservation stations 330, which are part of the waiting buffer and control module 132, and includes the thread execution units 134.

In various embodiments, the coprocessor control unit 310, the spawn waiting buffer 320, the thread reservation stations 330, and the thread execution units 134 are all implemented in hardware and/or firmware. In various embodiments, the thread reservation stations 330 may be or may include buffers.

There are various challenges to address for efficiently implementing asynchronous spawning in a hardware system. Various of the challenges are addressed below with respect to an example, which is referred to as a SAT solver application. The following description may refer to “regularity” and “irregularity.” As mentioned above, “irregular” and “irregularity” refer to situations where distribution of work and data defy pre-runtime characterization because they are input-dependent. In contrast, “regular” and “regularity” refer to situations where distribution of work and data can be characterized pre-runtime.

Portions of the following description refer to an example of challenges in efficiently implementing asynchronous spawning. The example relates to solvers for the propositional satisfiability problem (SAT), which are heavily used by hardware and software verification technologies. Workloads for such SAT solvers make heavy use of a routine known as unit propagation. Such a routine or similar ones manifest themselves in a variety of other applications, such as testing of hardware or software, as well as automated reasoning.

In the following description, (i) the term “scaling” may mean scaling up to more parallelism effectively, scaling down to less parallelism effectively, the flexibility of handling varied parallelism effectively, or doing any combination thereof, and (ii) stencil code may be provided in machine language, assembly language or any other form. The high-level form provided in the following description and in the drawings is for the sake of brevity for demonstrating content, rather than as a representative form.

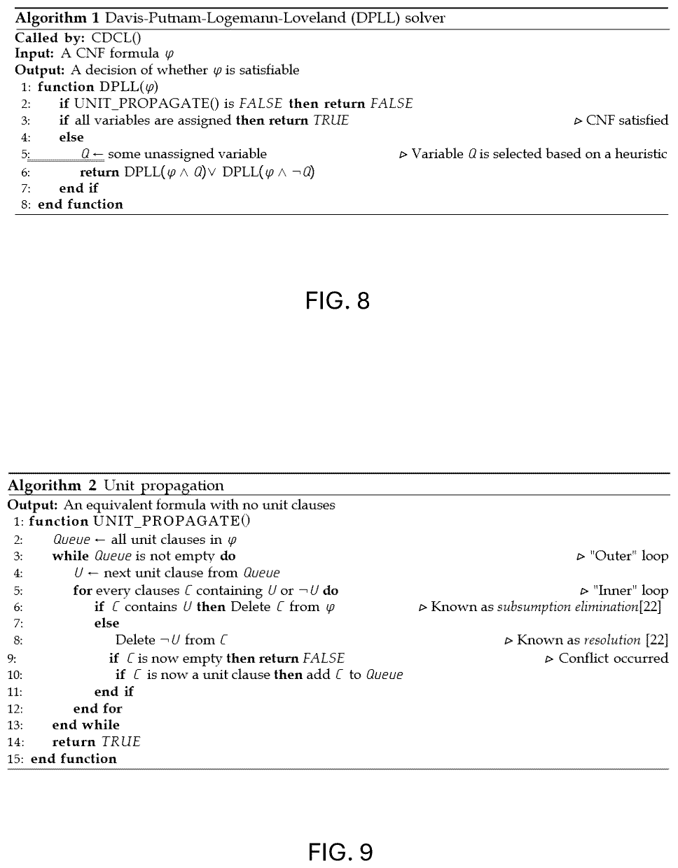

The following provides explanatory information and definitions in preparation for the description of FIGS. 8-14.

A Boolean variable (e.g., x) can take one of two values: TRUE or FALSE. A literal is a variable x or its negation (written ¬x). If x is TRUE, then its negation ¬x is FALSE and vice versa. A clause is a disjunction of literals (e.g., x V¬y Vz); a clause is TRUE (also called satisfied) if at least one literal in the clause is TRUE, and FALSE (also called unsatisfiable) if all literals are FALSE. A unit clause is a clause with exactly one literal. A formula in conjunctive normal form (CNF) (henceforth, formula) is a conjunction of clauses (e.g., (x V¬y)Λ(y Vz)); a formula is TRUE (satisfied) if all clauses in the formula are TRUE, and FALSE (unsatisfiable) if at least one clause is FALSE. The SAT problem is to decide whether a given formula is satisfiable.

The Boolean satisfiability problem is NP-complete: no (worst-case) polynomial time for SAT solving exists or is likely to be found in the future. Therefore, efficient SAT solvers rely on heuristics to provide good performance on practical inputs. An approach for SAT solving is the backtracking search algorithm. It traverses the search tree of all partial variable assignments in a depth-first manner until it finds a satisfying assignment or until it concludes that no such assignment exists and the formula is unsatisfiable. In various embodiments, SAT solvers may be based on the Davis-Putnam-Logemann-Loveland (DPLL) algorithm (see Algorithm 1 in FIG. 8). It traverses the search tree, depth-first, one variable at a time, assigning it either the TRUE or FALSE value. The worst-case time complexity of all backtracking algorithms is exponential in the number of variables.

To improve performance, all SAT solvers are engaged in 3 performance enhancing steps, aimed at pruning the search space explored.
1) Unit propagation. After each assignment, the CNF formula is simplified by unit propagation (see Algorithm 2 in FIG. 9); a form of constraint propagation that prunes the search space while moving forward, extending a partial solution by one more variable. If unit propagation generates an empty clause, the current assignment is declared a conflict; DPLL backtracks to the last variable it assigned, flips its value (from TRUE to FALSE or vice versa), and tries again.
2) Variable and value ordering heuristics. Unit propagation is also instrumental in facilitating look-ahead heuristics for selecting the next variable and its next value. These ordering decisions are known to have an immense impact on the size of the search tree explored, and thus on the running time of the algorithm.
3) Conflict-Directed Clause Learning (CDCL). When a conflict occurs, rather than naively backtracking to a previous assignment, the algorithm analyzes the reason for the conflict, and learns a new clause (or a “nogood”) that is added to the CNF formula, ensuring that the same conflict will not occur during the remainder of the search. In addition, instead of backtracking just one level, the algorithm can “backjump” multiple levels, thereby shortcutting parts of the search space that cannot lead to a solution.

Various software approaches to parallel SAT solving use the Portfolio approach—splitting the search space among multiple cores—and have realized only limited speedup. Modern SAT solvers spend about 90% of the time in the unit propagation step (Algorithm 2 in FIG. 9), which may have high amounts of parallelism. However, parallelization of this important step has been challenging, as this parallelism is irregular and the amount of parallelism keeps varying dynamically. This disclosure focuses on augmenting the traditional portfolio parallelization efforts with parallelizing this crucial step, to provide significant speedup on top of what is already possible.

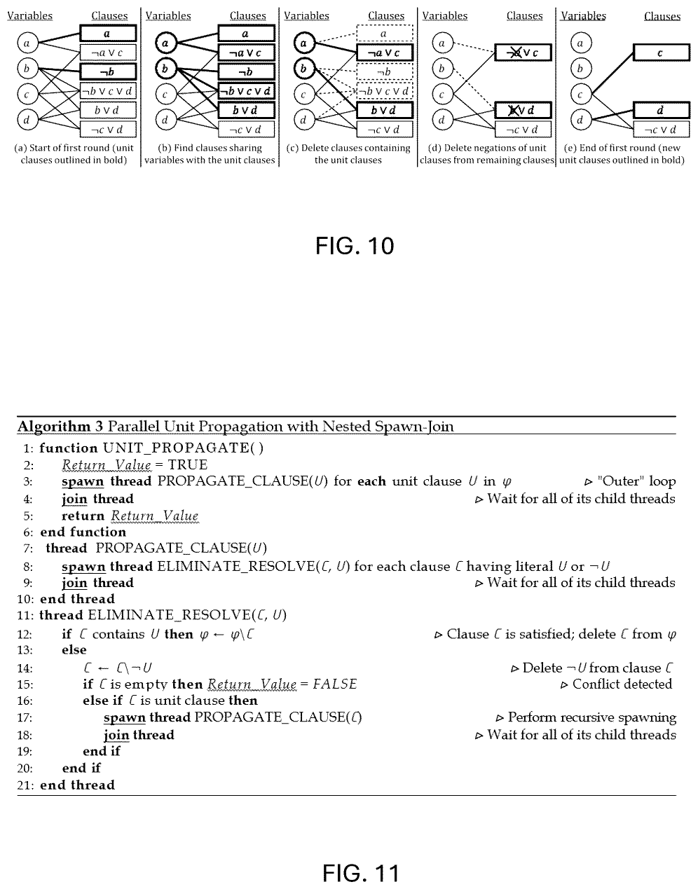

As written, the unit propagation step is a doubly nested loop akin to a breadth-first search (BFS) of a bipartite graph whose nodes are variables and clauses, with an edge connecting each clause to the variables it contains, as shown in FIG. 10. (Further aspects of FIG. 10 will be described below.) Because the BFS frontier consists of unit clauses, which have a fanout of 1, we can compress the traversal from unit clauses to variables and back to clauses into a single step; this “compressed BFS” will henceforth be simply called “BFS”. An approach would be to parallelize just the inner loop, with no nested spawning.

Although parallelization of the inner loop alone can provide some additional speedup, a lot more potential speedup is possible when both the inner and outer loops of Algorithm 2 (FIG. 9) are parallelized in a nested spawn-join manner, as depicted in FIG. 2, portion (a). In this parallelization model, a child thread can spawn its own child threads. Algorithm 3 (FIG. 11) shows a nested spawn-join parallel version of Algorithm 2 (FIG. 9). We parallelize the outer loop by processing all unit clauses simultaneously and the inner loop by processing all clauses containing a unit clause variable simultaneously. The algorithm uses recursive spawning by a child thread spawning a new thread for each new unit clause variable as soon as it is discovered to be a unit clause. This allows threads to start as early as possible (based on a hardware platform that supports efficient dynamic spawning of new threads within parallel code, as disclosed herein).

When a thread completes, its parent performs a join operation. The parent can proceed only after all of its spawned threads have completed. A disadvantage of the spawn-join approach is that the longest thread in a cohort must finish before their parent thread can continue. The problem is exacerbated when nested spawning is allowed. Moreover, nested spawning raises the hard question of how to implement nested spawn-joins with low overheads. Nesting-driven approaches have not sought to optimize overhead for short and repeated spawning. A fundamental question in this case is how to efficiently synchronize a parent thread with its children and grandchildren.

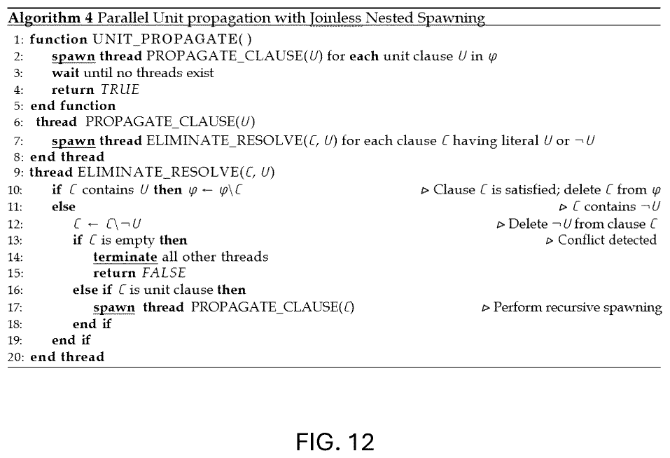

In aspects of the present disclosure, a technique for efficiently implementing nested spawns is to use a joinless approach, as depicted in FIG. 2, portion (b); i.e., a parent does not perform a join operation when each of its child threads completes. More importantly, it does not even keep track of its child threads. Algorithm 4 (FIG. 12) depicts the unit propagation routine that we have parallelized in this manner. Notice that none of the spawn statements in this algorithm have a matching join operation. A thread simply expires when its job is finished and does not wait for its child threads (if any).

There are significant levels of parallelism in unit propagation for abstract models of parallel computing, as well as significant variability of parallelism as the assumed processing progresses. However, traditional implementation of such parallelism, whether on conventional commercial hardware platforms or on many research stage ones, including implementation through traditional forms of multi-threading, encounter penalizing overheads. One reason for the overheads in some platforms is that they are optimized for cases where there is plenty of parallelism, or at least there is parallelism that exceeds a certain minimal threshold, or where parallelism can be effectively partitioned into sufficiently long threads rather than dynamically changing as a result of nesting of short threads, or where various parallelism characteristics are predictable ahead of time. Platforms may also be optimized only for other limited forms of parallelism aiming at specific workloads, or specific application domains.

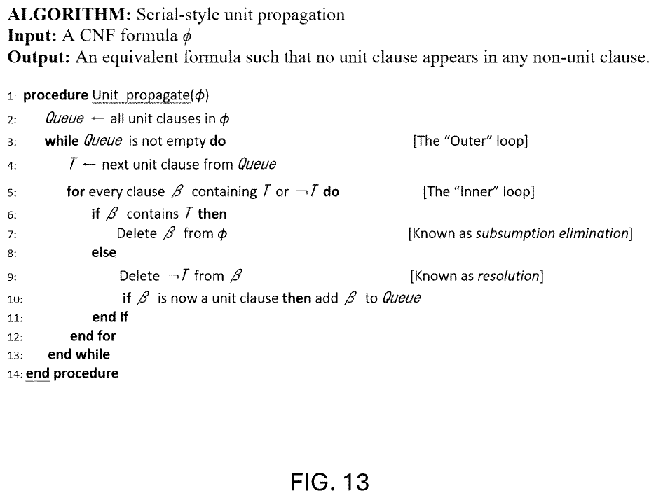

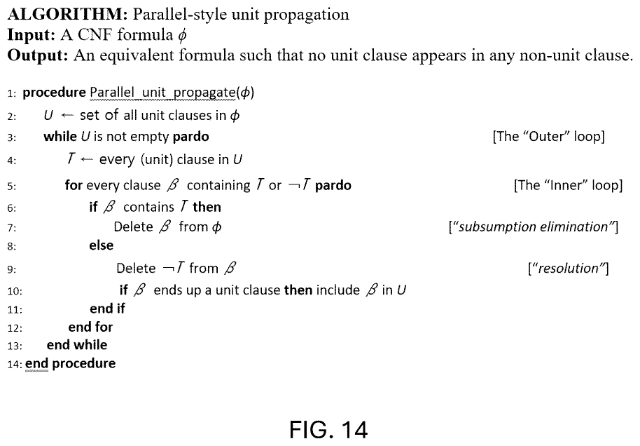

The following description refers to the parallelization of unit propagation (PUP). The PUP code includes a limited number of instructions in a “stencil” form. As mentioned above, the terms “stencil” or “stencil code” refer to same set of instructions that are executed in multiple instances, but each instance may involve different data elements. Execution of the PUP code may generally, but not exclusively, involve repeatedly recycling through the PUP code. In various embodiments, the “while” loop extending from line 3 to 13 in either FIG. 13 (the serial-style unit propagation) or in FIG. 14 (the parallel-style unit propagation) are examples of how stencil code may look.

In FIG. 14, a “pardo” command implies a plurality of instructions that can be executed in parallel. While these parallel instructions are assumed to execute in lock step, this assumption can often be relaxed, as long as the actual execution is consistent with a hypothetical lock step execution. Such relaxations can be provided by a programmer, compiler, runtime methods or a combination thereof, and form the basis for microthreads, later. The range of the plurality can be from one to some positive integer that may be bounded or unbounded, depending on implementation. In various embodiments, microthreads and nesting of microthreads can be specified directly. Namely, without involving in any way a “pardo” command, explicitly or implicitly. The pardo command reflects one of several possible options for expressing (i) parallelism, and (ii) affinity between current instructions and prior ones. Multithreading and data flow are other possibilities.

With regard to PUP, PUP recycles iteratively through a small number of instructions in a stencil form. The same instruction applies to a lot of data. The successor instruction of most instructions in the stencil will still be a single instruction. However, for at least one instruction in the stencil there may be a plurality of successor instructions. The range of the plurality can be from 0 to some positive integer that may be bounded or unbounded.

Some other instructions may require special attention. For example, some instructions lead to “arbitrary writes” (possibly implemented using a “test and set” primitive, or using prefix-sum to memory; e.g., per the University of Maryland XMT terminology), or by achieving an atomic operation effect through some form of serialization; e.g., serialization imposed by a memory controller within a memory module.

The following describes a top down SAT-solver view. The Conflict-Directed Clause Learning (CDCL) depth first search (DFS)-like SAT solving application of the Davis-Putman-Logemann-Loveland (DPLL) unit propagation (when parallelized it is basically the PUP) is fundamentally a speculation that either ends up with a success (satisfying assignment), with commitment of the speculation, or failure (the formula is not satisfiable) of the speculation. One top-down extension of the disclosed technology can include a Tomasulo-based speculation implementation of the full stack of the CDCL speculation.

A traditional serial-style version of the unit propagation procedure will be described with respect to FIG. 13, followed by an explanation of a parallel version with respect to FIG. 14.

The unit propagation procedure of FIG. 13 is an important routine in SAT solvers. For simplicity and clarity, description of a parallel unit propagation (PUP) is provided first through an example in FIG. 10 and then less formally in FIG. 14.

A graph whose nodes are the variables and the clauses of a conjunctive normal form (CNF) formula is shown in FIG. 10. With respect to FIG. 10, an edge connects the node of variable v to a clause node C if clause C includes ¬v or v as a literal. Rather than relying on a first-in-first-out serial-style queue data structure, line 2 of the parallel-style unit propagation pseudo-code in FIG. 14 implies a parallel data structure (PDS) representing a set that allows accessing a plurality of its entries more concurrently.

The parallel algorithm example in FIG. 10 starts with the two unit clauses, which dictate the truth value of their respective variables. In the example, the variables are different. But, in general, more than one clause can dictate the truth value of a variable. In case two of these dictates conflict, a “contradiction” is reached and reported to the overall program that issued the current call to the unit propagation procedure. In case no such conflict occurs, but two or more clauses seek to dictate the same truth value to a variable, the follow-up steps of the parallel algorithm will have the same effect as if just a single clause had dictated the same.

For clarity and simplicity, the cases where a plurality of the dictates occur, whether leading to contradiction or not, is described below, but not shown in FIG. 14.

The truth value of the variables is extended to literal occurrences of these variables in other clauses, leading to either removals of clauses: if the literal is set to true, or removal of the literal, if not. The case where all literals of some clause are removed leads to a similar “contradiction”, as above, and reported to the overall program that issued the current call to the unit propagation procedure. This case is again noted only in the above text, but for clarity and simplicity, is not shown in FIG. 14. Otherwise, if removal of literals produces more unit clauses, a new iteration led by said clauses begins.

While the above description of the parallel algorithm may imply lock step operation, the present disclosure encompasses a concurrent algorithm, whereby execution orders can be relaxed to become less synchronous, forming the type of microthreads expected by the accelerator (FIG. 1, 130).

As another example, including PUP, but more general than PUP, parallel wavefront routines for graphs consisting of vertices and edges are iterative: once a certain set of vertices, edges or a combination thereof has been reached, some rule is followed for progressing to a different such set. As noted in the case of PUP, description in the form of lock step iterative wavefront can often be relaxed into less synchronous operation, such as microthreads. Descriptions in other forms mentioned for PUP also apply. Also, in a wavefront example where individual microthreads correspond to all edges adjacent to a vertex, just storing vertices for later expanding to their adjacent edge, is one example for seeds of parallelism, a term explained later therein.

As mentioned above, there are various challenges to address, for efficiently implementing asynchronous spawning in a hardware system. Various of the challenges are addressed below, which may refer to aspects of the SAT solver application. The SAT solver application is provided merely as an example. It is intended and will be understood that the computation architecture of the present disclosure is applicable to other computations.

Thread granularity: The threads are short (typically less than 100 instructions). This makes it unprofitable to run them in current multicore architectures, with kernel-level threads (KLTs), as KLT creation involves a system call and a fair bit of setup. An operating system (OS) solution that may be adopted to deal with this overhead-a thread pool (a group of pre-instantiated, idle threads of similar function, that stand ready to be given work)—is not useful for the many irregular applications whose number of concurrent threads keeps changing significantly. If a big thread pool is created, an excessive number of threads in reserve will waste memory. If a thread pool that is too small is created, the benefits of using the thread pool may not be realized. Irregular applications, therefore, need a much more adaptive hardware spawn mechanism and a hardware-based thread scheduler that can directly schedule threads onto execution cores.

Thread irregularity: In the disclosed parallel algorithm, the length of a thread depends on the clause length and satisfiability and is irregular. Because of this irregularity, platforms such as GPUs cannot be used effectively. GPUs need regular threads that can be executed in lockstep, incurring performance degradation whenever threads diverge.

Thread spawn overhead: When executing a spawn command in hardware, the hardware spawn mechanism may encounter significant delays until all of the specified threads are spawned. Reasons include: (i) startup delay for spawning a thread, (ii) limited system resources, and/or (iii) bookkeeping overhead for keeping too many threads active, which could hurt performance.

Thread actuation and scheduling: Even when a thread is activated, it does not mean that there is enough hardware capacity to execute that thread. When there is limited hardware, there is a need to have a mechanism that: (i) dynamically controls which among the active threads is executed, (ii) schedules the execution of spawned threads based on when they are likely to begin execution, and (iii) accounts for the irregularity of memory access and their high latency risks.

Thread communication and synchronization overhead: The communication overheads of fine-grained threads may necessitate executing them all in a single core. However, single core multithreading techniques such as simultaneous multithreading do not provide scalable speedups.

Irregularity of memory access: The activation of clauses depends on the variables being propagated and their assignment. This means that memory access patterns can only be determined at run time.

Current multi-core and GPU platforms cannot cost-effectively address the above challenges. Efficient implementation of fine-grained parallelization is even more demanding, as it may involve nesting of threads, especially with asynchronous (re-)spawning. In aspects of the present disclosure, the components shown in FIG. 4 are capable of managing threads, including their scheduling on available thread execution units (which are very light) and the required synchronization. In aspects, the disclosed components include low-overhead hardware primitives to support nesting and asynchronous recursive spawning, as described below.

In aspects of the present disclosure, each main processing core 110 (e.g., general purpose CPU core) is augmented with a parallel-processing accelerator/coprocessor 130 that spawns threads asynchronously, dispatches them for execution only when they are ready, and lets them expire immediately when they have completed, without having them wait for a “join” operation. Various aspects and embodiments are described below. Such aspects and embodiments described below are merely examples. Variations of such aspects and embodiments are contemplated to be within the scope of the present disclosure.

Spawn Command Processing: Serial code will execute on the processing core as usual. When parallel code is reached, as evidenced by a Spawn instruction, the parallel-processing coprocessor 130 is activated, which will remain active until no more threads are active. The processor core 110 can continue to perform useful tasks, such as deciding on subsequent variable allocations, should the current assignment does not lead to a conflict. While the coprocessor 110 is active, its coprocessor control unit (CCU) 310 manages its activities. The CCU 310 keeps the spawn information in the Spawn Waiting Buffer (SWB) 320, from which the CCU 310 may spawn as many threads as the number of empty Thread Reservation Stations (TRSs) 330. When additional TRSs 330 become empty, additional threads are spawned based on the information stored in the SWB 320.

Thread Activation: When a TRS 330 gets a thread, it initiates the memory access(es) (e.g., irregular memory accesses) required to fetch the clause that thread needs. The spawned thread thus waits in a TRS until it receives the clause (similar in spirit to instructions waiting in a reservation station in a dynamically scheduled instruction-level parallelism (ILP) processor). When the clause becomes available, that thread is ready to execute, and is dispatched to an empty Thread Execution Unit (TEU) 330. The TEU executes the instructions of the assigned thread in its simple, in-order pipeline, without any synchronization with other threads. The TEUs maintain a copy of thread instruction to avoid re-fetching thread instructions from memory.

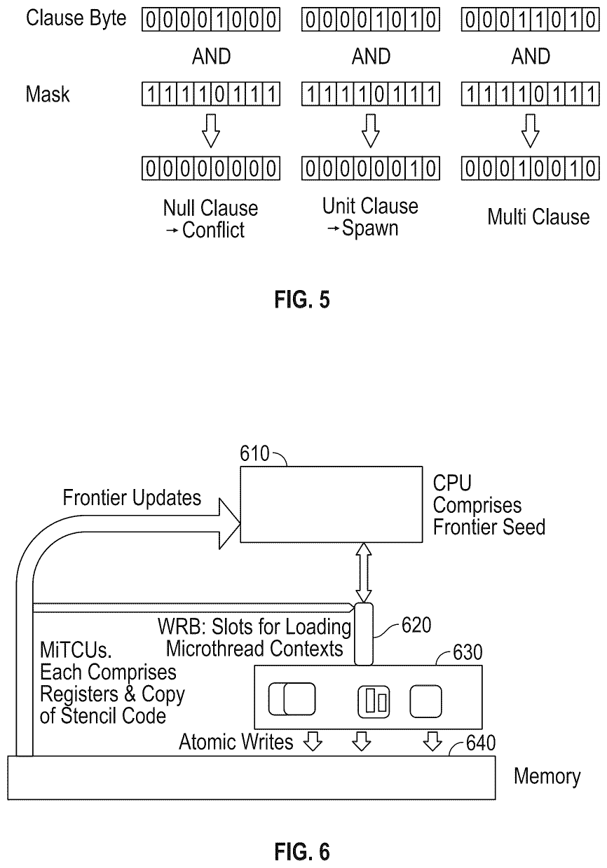

Thread Commit: When a thread whose clause C containing a unit variable U completes, its clause has been satisfied and needs to be deleted (e.g., step 10 of Algorithm 4, described below). This can be accomplished in software by setting the pointer to clause C as NULL. On the other hand, if the completing thread's clause contains the complement of U (i.e., ¬U), its clause needs to be updated. In addition, there is a need to identify if any of the following two special conditions has been reached: (1) the clause has become a null clause, indicating a conflict in the variable assignments, or (2) the clause has become a unit clause (steps 13 and 16, respectively, of Algorithm 4). Henceforth, in a yet more specific embodiment, it is assumed that a clause has up to 8 literals and is represented in memory as a byte-wide bitmap (every bit corresponding to a literal will be set to 1), as shown in the top row of FIG. 5 for three different clauses. (The data structures used in the software code are modified accordingly.) FIG. 5 is a diagram of an example relating to certain atomic instructions, in accordance with aspects of an embodiment the present disclosure. To perform the above update and identification with low overhead, a new atomic instruction is introduced for inter-thread synchronization, which is referred to herein as “mask-and-check instruction.” This instruction will apply a specified mask to a memory byte, whose bits correspond to the literals of a clause. The instruction checks if the updated byte is 0 (which means conflict) or a power of 2 (which means unit clause). Thus, steps 12-17 of Algorithm 4 are implemented by a single mask-and-check instruction. The example of FIG. 5 is illustrative, and a clause may have a different number of literals.

The implementation of this atomic instruction is now further described. First, after issuing this instruction, the thread expires and is vacated from its TEU 134, clearing the way for another ready-thread to be allocated to that TEU 134. When the atomic memory request reaches the cache memory, the cache controller performs the update as well as the checks for 0 and a power of 2. If any of these special conditions is satisfied, it informs the CCU 310 accordingly, which will then take appropriate action (including termination of all threads or further recursive spawning).

Further aspects and embodiments of the coprocessor 130 and/or the computation architecture are now described. The aspects and embodiments described below are merely examples. Variations of the aspects and embodiments are contemplated to be within the scope of the present disclosure.

Hardware-Based Nested Thread Spawning: In various embodiments, threads are created with a Spawn instruction, without involving the operating system. The Spawn instruction itself has negligible overhead; it is only telling the accelerator/coprocessor 130 that this is a point to create threads. To that end, the Spawn instruction specifies the number of threads to spawn and any additional information needed to identify the thread's code. In aspects, the accelerator/coprocessor 130 seamlessly incorporates nested spawning of threads without added overheads. It may be able to do so because the parallelization model does not enforce a strict parent-child relationship between the spawning thread and the spawned threads. This is achieved because the parent does not use “joins” to merge “sibling” threads. Instead, when a thread initiates a spawn, it vacates the TEU and the TEU can then be repopulated by another ready thread.

Hardware-Based Thread Management: In various embodiments, the management of the threads, before and after spawning, is done entirely in hardware, by the CCU 310. It does this management by performing the following:
1) The CCU 310 creates a “master copy” of spawning threads and places them in the Spawn Waiting Buffer (SWB) 320; when the number of pending Spawn commands exceeds capacity, further spawning is temporarily suspended.
2) When a Thread Reservation Station (TRS) 330 becomes available, the CCU 310 allocates a thread instance to the TRS 330, which then initiates the memory access (e.g., irregular memory access) needed to begin the execution of that thread. When the memory value becomes available, the thread is ready to execute.
3) The CCU 310 dispatches a ready-thread from a TRS 320 to a Thread Execution Unit (TEU) 330.
4) The CCU reclaims a Thread Execution Unit 330 when the allocated thread has executed its last instruction.

Token-Based Thread Allocation: An aspect of the disclosed computation architecture is that the binding of a spawned thread to a TEU 330 occurs only when the thread is ready to execute without significant further delays. Specifically, any memory values a thread needs that stem from irregular memory accesses are fetched by the TRS 320 before the thread is assigned to a TEU 330. Until this binding, the spawned thread waits in a TRS 320. Accordingly, the coprocessor 132 applies a dynamic scheduling algorithm to threads. In embodiments, the dynamic scheduling algorithm may be Tomasulo's dynamic scheduling algorithm applied at the level of threads. Other dynamic scheduling algorithms are contemplated. It is worth noting again that active threads are executing at their own pace and are not operating in lockstep.

Limited Inter-Thread Synchronization: In various embodiments, during execution, a thread only reads shared data (e.g., clauses) and does not write to shared data. A thread updates shared data only when it is about to expire. Thus, the threads do not wait for any communication from other threads and can therefore execute at its own pace as permitted by memory access latencies. If multiple threads expire at the same time and try to simultaneously update the same shared data, these updates can be serialized. In various embodiments, a particular way is implemented for threads to perform these updates at completion, i.e., the updates can be performed as atomic operations using simple in-memory computation. An example is disclosed in G. Singh, et al., “A review of near-memory computing architectures: Opportunities and challenges”, In 2018 21st Euromicro Conference on Digital System Design (DSD), pages 608-617 (2018), which is hereby incorporated by reference herein in its entirety.

Shared Memory System and Interconnect: In various accelerator designs, the host memory may be separate from the accelerator memory, and explicit data transfer to and from the accelerator memory is needed to perform the computation and get the results. In irregular applications, the cost of this data transfer is harder to amortize, since the data reuse in the accelerator is lower than in regular applications. In aspects of the present disclosure, the accelerator 130 avoids expensive data transfers between the processing core 110 (e.g., CPU core) and the coprocessor 130 by tightly coupling them—allowing the coprocessor 130 to utilize the memory system 120 and its address translation mechanism.

In various embodiments, the memory system 120 utilizes a hierarchy in order to satisfy low latency. At the top of the hierarchy is a shared multi-bank cache memory. The processing core 110, the TRSs 320, and the TEUs 330 are connected to the shared cache memory banks through an on-chip interconnect, such as an Omega network or mesh-of-trees. Misses from the cache memory are routed to the main memory. Other implementations of the memory system 120 are contemplated and are within the scope of the present disclosure.

3D Chiplet Implementation and Power Consumption: In various embodiments, in the computation architecture, the processor core 110, the TRSs 320, and the TEUs 330 all access a shared cache memory in the memory system 120. A high bandwidth cache memory system is helpful for the accelerator 130 to provide speed-up. Technologies such as 3D stacked memory can provide substantially more bandwidth than conventional 2D memory systems. In various embodiments, the computation architecture leverages 3D stacked memory technology. The hardware implementation may fundamentally be a drastically trimmed version of a more demanding design in terms of both power consumption and silicon area. The accelerator 130 would not use speculative execution or extra memory movements, and hence would not increase the energy consumption.

Accordingly, aspects and embodiments of the computation architecture of FIG. 4 have been described above. Such aspects and embodiments are merely examples and do not limit the scope of the present disclosure. One or more of the descriptions, aspects, and/or embodiments may be combined in any combination. Such and other variations are contemplated to be within the scope of the present disclosure.

Another embodiment of the computation architecture is now described in connection with FIG. 6.

FIG. 6 is a diagram of an example of the computation architecture and includes: (i) a host system 610 (e.g., a CPU) that is labeled as a CPU, (ii) a waiting room buffer (WRB) 620 having slots for microthread contexts, (iii) microthread control units (MiTCUs) 630, each having registers and small instruction memory that can hold stencil code, (iv) memory 640 that can accommodate some forms of atomic writes, or their equivalents for indication of follow-up microthreads, and (v) communication of the indication to the WRB 620 and host system 610. In various embodiments, communication directly to the MiTCUs 630 may be implemented, especially when too little parallelism is available.

The host system 610 and the processing core 110 correspond to each other, and descriptions, operations, aspects, and embodiments of one maybe applied to the other. The WRB 620 and the waiting buffer and control module 132 (and its components) correspond to each other, and descriptions, operations, aspects, and embodiments of one maybe applied to the other. The MiTCUs 630 and the thread execution units (TEUs) 134 correspond to each other, and descriptions, operations, aspects, and embodiments of one maybe applied to the other. The memory 640 and the memory system 120 correspond to each other, and descriptions, operations, aspects, and embodiments of one maybe applied to the other.

With continuing reference to FIG. 6, instead of relying on traditional mechanisms such as a traditional instruction memory hierarchy (coupled with a CPU core program counter), the disclosed technology adds, to a host system, a self-repopulated integrated acceleration apparatus, or method, for execution of stencil code. As mentioned above, stencil code refers to threads generated from a Spawn command that execute the same set of instructions but on different data elements.

As mentioned above, the self-repopulated integrated acceleration apparatus includes at least: (i) a plurality of the microthread control units (MiTCUs) 630 having small instruction memory and several local registers, and (ii) the waiting room buffer (WRB) 620 having a plurality of slots. The computation architecture operates to execute stencil code representing microthreads. The term “microthread” refers to a thread that executes a relatively small amount of code, such stencil code often is.

One scenario for the operation of the self-repopulated integrated acceleration apparatus is as follows:
1. A copy of the stencil code at hand or sections thereof can fit into the instruction memory of a MiTCU 630.
2. Code has been preloaded into the instruction memory of the MiTCU 630.
3. The local registers of a MiTCU 630 can hold all the data needed for completion of one or more sections of a microthread.
4. Having been preloaded to the WRB 620, the section is (or sections are) ready for the MiTCU 630 when needed for execution.
5. The consequences of the last instruction of a microthread can be the indication of new follow-up microthreads, including the case of no follow-up microthreads. This indication may require atomic-operation-like functionality with respect to memory visible outside the MiTCU 630 in order to account for concurrent operations by other MiTCUs 630, and in order to communicate said indication to other components of the accelerator, or of the host system 610 or both. An implementation of one family of atomic operations was described above with respect to FIG. 4 and FIG. 5. The option of executing one section of a microthread at a time, rather than the whole microthread may allow moving the remainder of the microthread to the WRB 620 for prefetching memory requests of one or more later sections. Operating on sections also allows fewer local registers at a MiTCU 630.

In various embodiments, for improved utility, the WRB 620 includes a sufficient plurality of slots to, in effect, hide delays, in loading data from the memory 640, from a MiTCU 630. Sufficient parallelism may allow the scenario above. In various embodiments, there may be two deviations:
1. “Insufficient parallelism”. As long as not enough MiTCUs 630 are active, it may be beneficial to get them started with executing a microthread even before all of the data is available, thereby bypassing use of the WRB 620.
2. “Too much parallelism”. As more parallelism is being expanded (e.g., through spawn instructions), said parallelism may, at times, exceed the capacity of the accelerator unit. In order to reign in such a “parallelism frontier” from occupying more hardware capacities than needed, the implementation may seek to suspend such expansion until resources become available to take on said parallelism. For example, in case all WRB slots 620 are taken or the WRB slots are approaching fullness (e.g., slots are a certain percentage full, e.g., 90%, or otherwise), a software approach can compactly hold at the host system 610 the “seed” of the parallelism that prior microthreads have indicated at the host system 610. Such seed can be a compact data structure that, upon expansion by the host system 610, can later provide individual microthreads. “Recursive” emergence of such seeds from the memory 640 may occur. With respect to the SAT solver example, the unit propagation example may result in such recursive emergence of seeds from the memory 640.

Possible embodiments of the host system 610 include, without limitation, a variety of information processing systems, such as various multi-core or single core environments.

In various embodiments, fast allocation of microthreads to WRB slots 620, or MiTCUs 630 (as well as repopulation of such slots or MiTCUs) can be performed using a primitive. One possibility is the prefix-sum primitive introduced in U.S. Pat. No. 6,542,918, which is hereby incorporated by reference herein in its entirety. The prefix-sum primitive, for example, allows computing the prefix-sums of, for example, 64 single bits, each coming from a different microthread within a unit time. In case inputs to a prefix-sum computation are not limited to 0 and 1, the same prefix-sum primitive can be applied (in parallel) to each bit in the binary representation of the inputs towards the allocation.

In various embodiments, on chip interconnects, such as those disclosed in U.S. Pat. No. 6,768,336, or other approaches and methods in this field, can be used for the design of data movement in the chip. The entire contents of U.S. Pat. No. 6,768,336 are hereby incorporated by reference herein. Persons skilled in the art will recognize such other approaches and methods.

In various embodiments, execution of instructions can occur separately for individual MiTCUs 630. A non-inclusive list of potential implementations include: pipelined, superscalar, long instruction word (LIW)/very long instruction word (VLIW), and simultaneous multithreading (SMT) executions, or combinations thereof. Persons skilled in the art will understand such implementations.

In various embodiments, the computation architecture is provided as a monolithic WRB 620 and hierarchy-free MiTCUs 630.

In various embodiments, clustered and/or hierarchical variants, where, for example, the WRB 620 includes several “waiting rooms” and each can feed only a subset of the MiTCUs 630, are contemplated to be within the scope of the present disclosure.

In various embodiments, a different, yet related, further allocation (and repopulation) involves having successive microthreads or instruction sections allocated either to available MiTCUs 630, or, depending on an allocation policy, to the WRB 620, to be later moved into a MiTCU 630 once available.

In various embodiments, WRB slots 620 may be fully subscribed to be managed by the host system 610.

Various descriptions, operations, aspects, and embodiments of the computation architecture are described above in connection with FIG. 6. One or more of the descriptions, operations, aspects, and embodiments may be combined in any manner. Additionally, one or more of the descriptions, operations, aspects, and embodiments described in connection with any of FIGS. 1-6 may be combined in any manner.

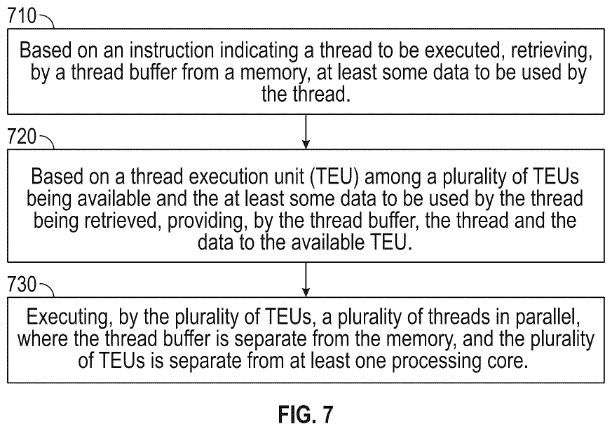

Referring now to FIG. 7, there is shown a flow diagram of an operation in an accelerator apparatus that cooperates with at least one processing core and a memory. The operation of FIG. 7 may be performed by the accelerator of FIG. 4 or the accelerator of FIG. 6, for example.

At block 710, the operation involves, based on an instruction indicating a thread to be executed, retrieving, by a thread buffer from a memory, at least some data to be used by the thread.

At block 720, the operation involves, based on a thread execution unit (TEU) among a plurality of TEUs being available and the at least some data to be used by the thread being retrieved, providing, by the thread buffer, the thread and the data to the available TEU.

At block 730, the operation involves executing, by the plurality of TEUs, a plurality of threads in parallel, where the thread buffer is separate from the memory, and the plurality of TEUs is separate from at least one processing core.

The operations of FIG. 7 are merely examples, and variations are contemplated to be within the scope of the present disclosure. For example, in various embodiments, the operations may include other operations not shown in FIG. 7. In various embodiments, certain operations may be performed together or a certain operation may be performed by separate sub-operations. Such and other variations are contemplated to be within the scope of the present disclosure.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include or be associated with a memory that stores data and/or instructions which, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. An accelerator apparatus cooperating with at least one processing core and a memory, the accelerator apparatus comprising:
a plurality of thread execution units (TEU) configured to execute a plurality of threads in parallel; and
a thread buffer interconnected with the plurality of thread execution units,
wherein, based on an instruction indicating a thread to be executed, the thread buffer retrieves, from the memory, at least some data to be used by the thread,
wherein, based on a TEU among the plurality of TEUs being available and the at least some data to be used by the thread being retrieved, the thread buffer provides the thread and the at least some data to the available TEU, and
wherein the thread buffer is separate from the memory, and the plurality of TEUs is separate from the at least one processing core.

2. The accelerator apparatus of claim 1, wherein each TEU of the plurality of TEUs is configured to perform processing independently of any other TEU of the plurality of TEUs.

3. The accelerator apparatus of claim 1, wherein each TEU of the plurality of TEUs is configured to execute a thread and to terminate the thread after execution of the thread is completed, wherein the thread is terminated without waiting for any child threads to be completed.

4. The accelerator apparatus of claim 1, wherein each TEU of the plurality of TEUs is configured to execute a same stencil code.

5. The accelerator apparatus of claim 4, wherein each TEU of the plurality of TEUs comprises an instruction memory storing the stencil code, wherein the stencil code is preloaded into the instruction memory of each of the TEUs prior to any data being provided to the TEU for thread execution.

6. The accelerator apparatus of claim 1, wherein in the thread buffer retrieving, from the memory, the at least some data to be used by the thread, the thread buffer performs an irregular memory access.

7. The accelerator apparatus of claim 1, wherein the thread buffer holds the at least some data until a TEU among the plurality of TEUs becomes available.

8. The accelerator apparatus of claim 1, further comprising a spawn waiting buffer configured to hold spawn information of a thread.

9. The accelerator apparatus of claim 8, wherein, based on a slot of the thread buffer being available, the spawn waiting buffer spawns a thread and provides the spawned thread to the available slot of the thread buffer.

10. The accelerator apparatus of claim 9, wherein the spawn waiting buffer holds the spawn information and does not spawn a thread until a slot of the thread buffer becomes available.

11. The accelerator apparatus of claim 1, further comprising a control unit, wherein the control unit is configured to:
provide spawn information of threads to the spawn waiting buffer,
provide an indication to the spawn waiting buffer based on a slot of the thread buffer being available, and
provide an indication to the thread buffer based on a TEU of the plurality of TEUs being available.

12. The accelerator apparatus of claim 11, wherein the control unit dynamically controls spawning and execution of threads.

13. The accelerator apparatus of claim 12, wherein in the dynamic control, the control unit, based on the spawn waiting buffer being full or approaching fullness, suspends further spawning of threads and causes storage of seeds, the seeds comprising information of threads to be spawned.

14. The accelerator apparatus of claim 12, wherein in the dynamic control, the control unit dynamically allocates an available TEU of the plurality of TEUs to receive a spawned thread from the thread buffer.

15. The accelerator apparatus of claim 1,
wherein the available TEU executes the thread; and
wherein in case the executing the thread spawns a nested thread, the thread buffer is repopulated with the nested thread by the thread buffer receiving and storing the nested thread.

16. The accelerator apparatus of claim 15, wherein the available TEU terminates the thread after execution of the thread is completed, wherein the thread is terminated without waiting for the nested thread to be completed.

17. An integrated system comprising:
a host system; and
the accelerator apparatus of claim 1.

18. A method in an accelerator apparatus cooperating with at least one processing core and a memory, the method comprising:
based on an instruction indicating a thread to be executed, retrieving, by a thread buffer from the memory, at least some data to be used by the thread; and
based on a thread execution unit (TEU) among a plurality of TEUs being available and the at least some data to be used by the thread being retrieved, providing, by the thread buffer, the thread and the at least some data to the available TEU; and
executing, by the plurality of TEUs, a plurality of threads in parallel,
wherein the thread buffer is separate from the memory, and the plurality of TEUs is separate from the at least one processing core.

19. The method of claim 18, wherein each TEU of the plurality of TEUs is configured to perform processing independently of any other TEU of the plurality of TEUS.

20. The method of claim 18, wherein each TEU of the plurality of TEUs is configured to execute a thread and to terminate the thread after execution of the thread is completed, wherein the thread is terminated without waiting for any child threads to be completed.
